(19) United States
(12) Patent Application Publication
(10) Pub. No.: US 2005/0106547 A1
(43) Pub. Date: May 19, 2005

(54) Device for use as learning aid or educational toy

(75) Inventor: Andrew Shun Pui Chiu, Kowloon (HK)

Correspondence Address: WILLIAM J. SAPONE;COLEMAN SUDOL SAPONE P.C., 714 COLORADO AVENUE, BRIDGE PORT, CT, 06605, US

(73) Assignee: Ngai Keung Metal & Plastic Mfy. Ltd., Kowloon (HK)

(21) Appl. No.: 10/958,995

(22) Filed: Oct. 5, 2004

(30) Foreign Application Priority Data
Oct. 7, 2003 (CN) 200310111722.6

(51) Int. Cl. G09B 1/00

(52) U.S. Cl. 434/317

(57) ABSTRACT

A learning aid adapted to identify an icon on an object, comprising a pointer means, a central processing unit, and a response generating means, wherein said pointer means includes an optical color detector adapted to detect color or colors of said icon when placed in close proximity thereof and wherein said response generating means is adapted to provide a response corresponding to said detected color or colors.

### FIELD OF THE INVENTION

The present invention is generally concerned with a device which may be used as a learning aid or an educational toy.

### BACKGROUND OF THE INVENTION

There are a variety of conventional electronic books. These books are often used as tools for assisting children in learning including identification of objects and pronunciation of words. Briefly, these books are able to interact with a user such that when the user, for example, points at a certain object printed on the book, the book is able to output an audio signal corresponding to the pointed object. Through the use of such an electronic book, a child, for example, can learn while interacting with the book. This type of electronic books is sometimes described as “listen-able electronic books”. They usually comprise a central processing unit, a memory means connected to the central processing unit, an integrated audio chip connected to the central processing unit and a speaker connected to the integrated audio chip. This type of electronic books can translate the printed contents of the books to audio signals recognizable by a user who may be a child.

FIG. 1 illustrates the structure of a typical electronic book 1 available in the market, the book 1 comprises a detection base 2, a book body 4 and a corresponding data card 6 for use in association with the book body 4, The detection base 2 is provided with a recess area 8 in which the book body 4 is placed. The detection base 2 is also provided with a slot 10 into which the data card 6 corresponding to the book body 4 may be inserted. In use, when a certain content, which may be a color, a pattern or a sign, on a page of the book body is contacted by a pen-like object (not shown), the detection base 2 equipped with a specker is then able to output a sound corresponding to the content contacted. The mechanism of the electronic book 1 is that when sensors in the recess area of the detection base beneath the book body sense the location of contact or pressure by the pen-like object, the sensors will output a signal to a central processing unit connected thereto. Depending on the signal received, the central processing unit therein will cause a speaker connected to the detection base 2 to output a sound corresponding to the content contacted, and as a result a user of the electronic book 1 will be able learn the content aurally. For example, if there is a cow on one of the pages of the electronic book 1 and the cow on that page is contacted by the user via the pen-like object, the electronic book 1 is able to pronounce the word “cow” and the user will know that the contacted object is a cow.

The above-described electronic book however suffers a number of disadvantages. For example, in use, the book body must be placed in and in contact with the detection base which is often relatively bulky and difficult to handle. Further, an electronic book of this type is often limited to work with a limited number of book bodies. In addition, an electronic book of this type normally has a limited number of pages.

It is thus the object of the present invention to provide an improved device which may address the above disadvantages.

### SUMMARY OF THE INVENTION

According to a first aspect of the present invention, there is provided a learning aid, a learning aid device or the like adapted to identify an icon or icons on an object, comprising a pointer means, a central processing unit, and a response generating means, wherein the pointer means includes an optical color detector which is adapted to detect color or colors of said icon or icons when placed in close proximity thereof and wherein the response generating means is adapted to provide a response corresponding to the detected color or the colors. Each icon is a colored icon or a colored label means. It is to be noted that the icon or icons may have a single color or multiple colors, as shown in FIG. 12. It is to be noted that the icon or icons may comprise an illustration such as alphabets, words or passages, or labels located adjacent the alphabets, the words or the passages.

Preferably, the pointer means may be a pen-like object or an article suitable for use as a pointer and to be held by a user.

Suitably, the learning aid may comprise a signal transmitting means adapted to convert signal or color detected by the optical detector to a digital signal. The central processing unit may be adapted to receive the digital signal and generate an output signal corresponding to the detected color or colors of the icon(s). In particular, the learning aid may comprise a memory means connected to the central processing unit, wherein the memory means is stored with information of colors (of the icons) and respective response files, and the central processing unit determines the output signal therefrom based on the information in the response files of the memory means.

Advantageously, the response generating means may comprise a speaker adapted to output an audio signal. Alternatively, the response generating means may comprise a motor means adapted to move a part of the object. Yet alternatively, the response generating means may be a lighting means adapted to output a visual signal.

Preferably, the optical color detector may be adapted to detect single colors.

Alternatively, the detector may be adapted to detect multiple colors.

Suitably, the colored icon(s) may be in two- or three-dimensional form.

Advantageously, the pointer means may include the signal transmitting means and/or the central processing unit. The incorporation of the signal transmitting means or the central processing unit in the pointer means may be desirable because it increases portability of the pointer means.

Preferably, the learning aid may be adapted to be used as an educational toy, and in particular a toy for teaching children to identify colors or objects, or to learn an act such as raising an arm.

Preferably, the object may be a book with pages having planar surfaces or a doll in three-dimensional configuration.

According to a second aspect of the present invention, there is provided a kit comprising a learning aid or a learning aid device as described above and the object. In particular, the object may a book, and in such case the learning as may be adapted to teach children to identify objects or colors or to learn the pronunciation of the objects or the colors. Alternatively, the object may be a doll, and in such case the learning aid may be adapted to teach children to describe or learn an act such as raising an aim. While the signal transmitting mean is and/or response generating means may be included in the pointer means, they may alternatively be included in the object.

### BRIEF DESCRIPTION OF THE DRAWINGS

Some embodiments of the present invention will now be described by way of examples and with reference to the accompanying drawings, in which:—

FIG. 1 is a conventional electronic book;

FIG. 2 is a kit comprising a book (or a book body) and electronic means according to an embodiment of the invention;

FIG. 3 is a schematic diagram illustrating the structure of the electronic means of kit shown in FIG. 2 in use;

FIG. 4 is a flow chart illustrating the working of the kit and in particular of the electronic means in FIG. 2;

FIG. 5 is a cross section view of an optical color detector in a pointer means of the kit shown in FIG. 2;

FIG. 6 is simplified schematic circuit diagram illustrating the circuit of the optical color detector shown in FIG. 5;

FIG. 7 is a book for use with the kit shown in FIG. 2;

FIG. 8 is another book for use with the kit shown in FIG. 2;

FIG. 9 is yet another book for use with the kit shown in FIG. 2;

FIG. 10 is a cross section view of an optical color detector which may be used in the kit;

FIG. 11 is a cross section view of another optical detector different from the one shown in FIG. 10 which may alternatively be used in the kit, the figure illustrating the detection of an icon having multiple colors;

FIG. 12 illustrates an example of an icon have multiple colors.

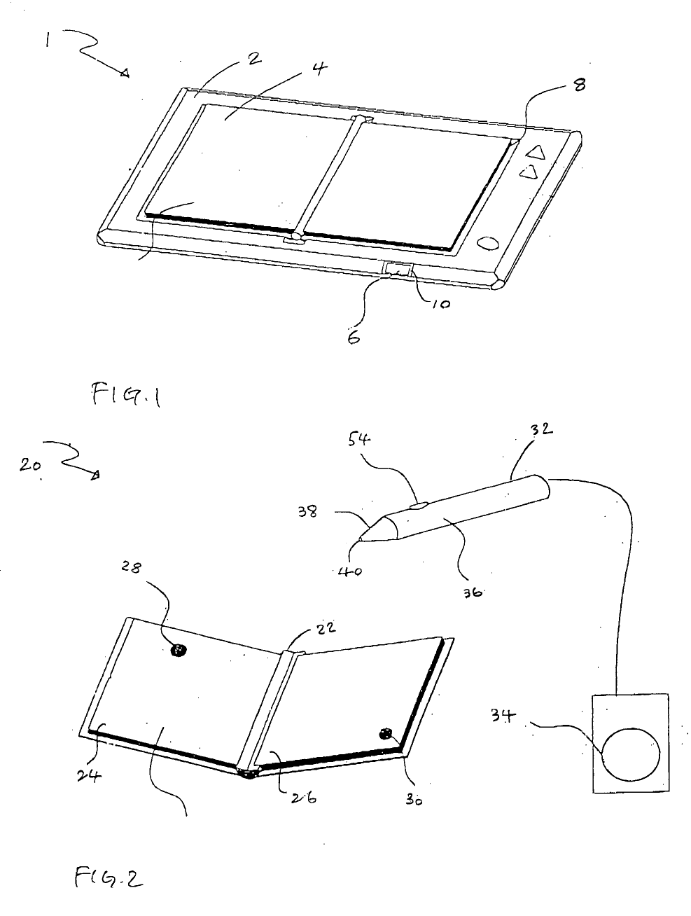

### DESCRIPTION OF THE PREFERRED EMBODIMENTS OF THE INVENTION

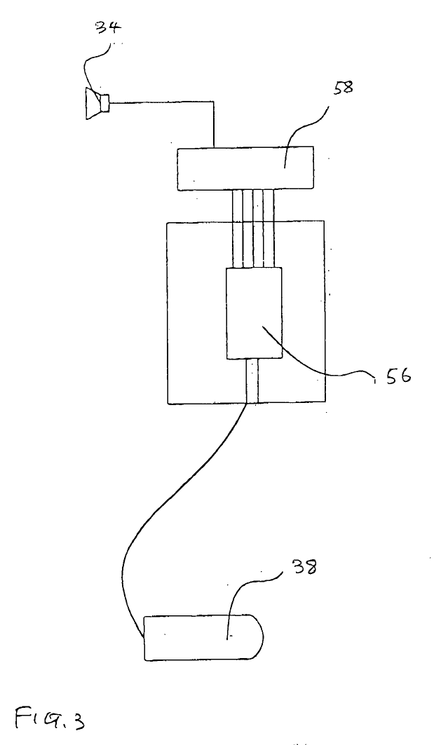

Referring firstly to FIGS. 2 to 4 and particularly FIG. 2 there is shown schematically a learning aid in the form of an electronic book in accordance with an embodiment of the present invention. The electronic book, generally designated as 20, comprises a book body 22 and electronic means.

The book body 22 comprises a plurality of pages 24, 26. There are provided a number of labels 28, 30 in the form of icons located in or adjacent to objects or illustrations that are intended to teach a reader (e.g. a child) the identification and/or the pronunciation of the names of the objects.

The electronic means comprises a pen-like object 32 and a speaker 34. The pen-like object 32 includes a lower portion 36 in which a color detector 38 (see FIG. 5) is housed, a central processing unit 56 connected to the color detector 38 and a memory unit 58 connected to the central processing unit 56. As shown in FIG. 5, the lower portion 36 of the color detector 32 is provided with an aperture 40. The color detector 38 comprises a circuit board 48, two LEDs 50, 52 at opposite sides in the lower portion 36, a planar barrier 42 provided with an aperture 44 and a color sensing chip 46 located adjacent the circuit board 40. Each of the LEDs 50, 52 is inclined in relation to the longitudinal axis of the pen-like object 32. The LEDs 50, 52 in this embodiment are diodes adapted to emit white light. The pen-like object 32 is also provided with a control button 54 at the lower portion 36. While the central processing unit and the memory unit are provided in the pen-like object 32 in the present embodiment, it is envisaged that they may be provided separately independent of the pen-like object.

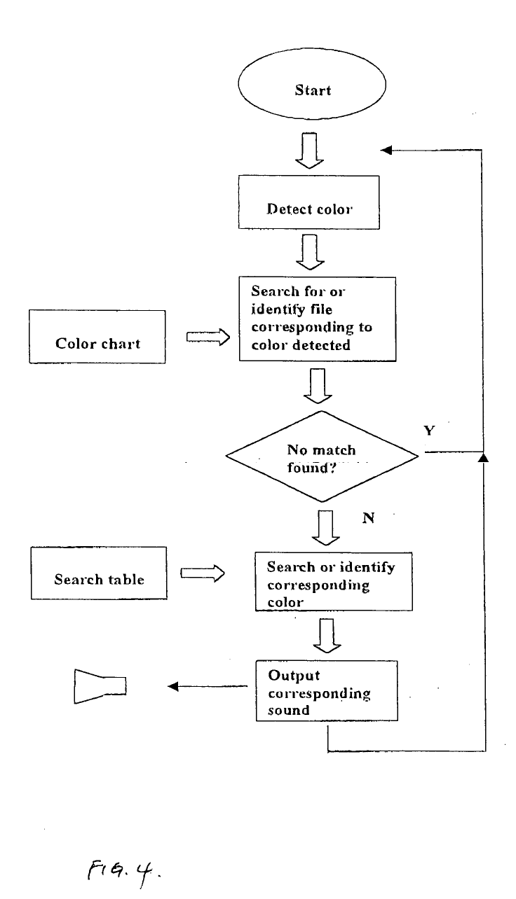

FIG. 4 illustrates the working of the electronic book 20. The control button 54 on the pen-like object 32 is adapted to activate the circuit of the various electronic means thereof. The electronic means may be caused to start an operation on pressing the control button. The color detector 38 is able to scan a color label of interest on a surface 60 when contacting or brought into close proximity of the color label 60 and detect the color of the label 60. After scanning, the color detector 38 will seek to read or identify the color thereof. If the detector is unable to read the color it will seek to scan the color label again. If the detector is able to read the color, the detector will register the respective color data and generate a corresponding signal, and the electronic means will operate further as follows. The central processing unit 56 of the electronic means will locate a sound file in the memory unit 58 matching the color data and output a signal to the speaker 34 for pronouncing the color of the color label based on the color data.

In use, when the pen-like object 32 held by a user scans a label and at the same time the user presses the control button 54, the speaker 34 of the electronic book will output a word corresponding to the label. For example, if the label contacted is in red, the speaker will pronounce the word “red”. It is envisaged that an electronic book according to the present invention is useful as a learning aid for teaching children to identify color, and to pronounce or to describe colors.

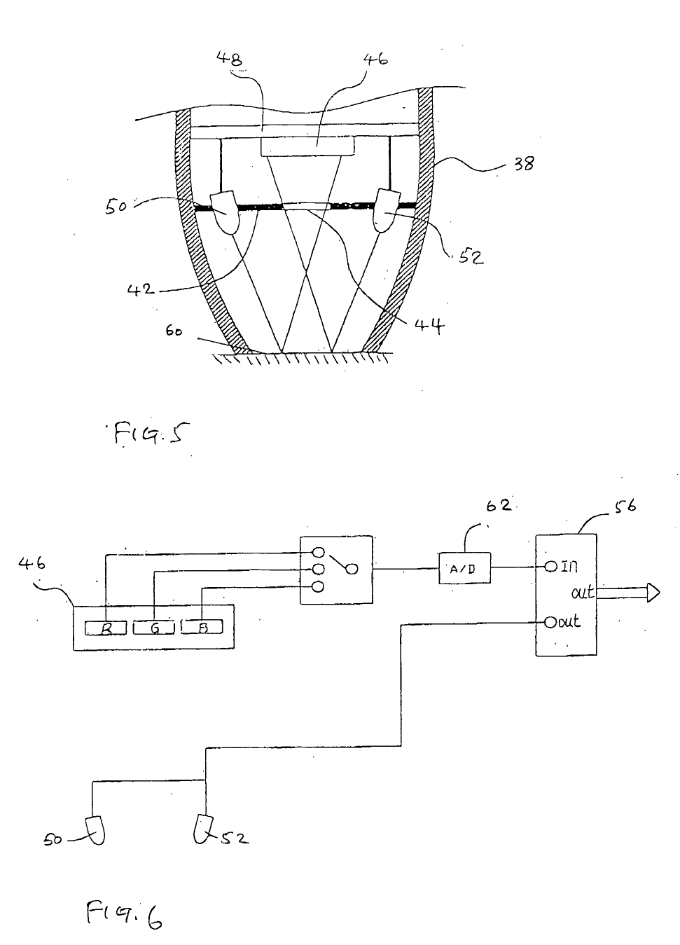

FIGS. 5 and 6 illustrate the lower portion 36 and the working of the color detector 38 therein in greater detail. As shown in FIG. 5, when the lower portion 36 contacts the surface 60 hearing a color label at the aperture 40, and the control button 52 is pressed, the detector is initiated with the LEDs 50, 52 emitting light directing towards the color label. Due to the inclined position of the LEDs 50, 52 and thus the light path, light emitted from the LEDs 50, 52 after reaching the color label is reflected back to the detector 38 via the aperture 44 of the barrier 42 and reaching the color-sensing chip 46.

The barrier 42 is provided to enhance the accuracy of the detection of the reflected light. The chip 42 adopts a red-green-blue (RGB) three-color sensing technology, receives the reflected light and output a signal corresponding to the color label and reflected light. The signal is converted to a digital signal by a signal transmitter 62. The digital signal is then analyzed by the central processing unit 56.

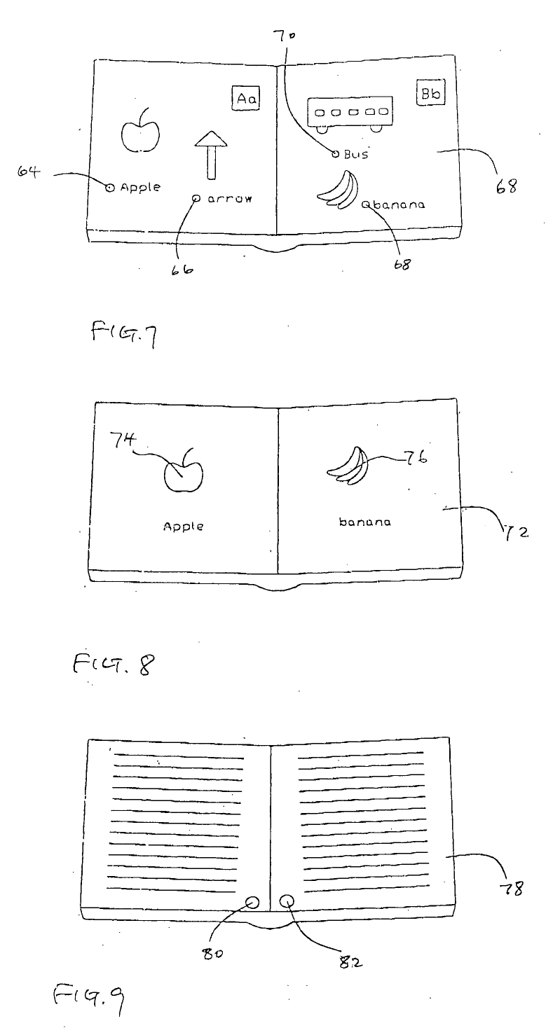

It is envisaged that an electronic book in accordance to the present invention may also be used as a learning aid for teaching children to identify other labeled objects (e.g. fruits, animals, etc.) other than colors, as illustrated for example in FIGS. 7 and 8. In the case of FIG. 7, the learning aid and a book body 68 are intended to teach the identification and the pronunciation of English words starting with the alphabet “a”. In this learning aid, the memory unit of the electronic means is designed such that each color (e.g. red) label is located near an object (e.g. apple), and on detecting the color label, the output digital signal corresponding to the color of the reflected light is linked to a file for the pronunciation of “apple”. In particular, when the pen-like object held by a user contacts a color label 64 near the apple, instead of pronouncing the word “red”, the speaker pronounces the word “apple”. When the user contacts a color label 66 adjacent to the arrow, the speaker 34 pronounces the word “arrow”. This learning aid is thus able to assist users to identify objects (e.g. “apple” or “arrow”) and to pronunciate groups of words sharing certain first alphabet. The same applies when contacting labels 68, 70 which correspond to the words “banana” and “bus”.

FIG. 8 illustrates another embodiment of a learning aid according to the present invention. This learning aid and a book body 72 in this embodiment are different from the previous embodiment in that the book body 72 contains pages on which various types of fruits in appropriate matching colors but without any distinct adjacent color labels are printed. In use, a user can simply contact the fruit of interest with the pen-like detector and the speaker will output a corresponding sound. For example, if an apple 74 is contacted the speaker will output the word “apple”. If a banana 76 is contacted, the speaker will output the word “banana”.

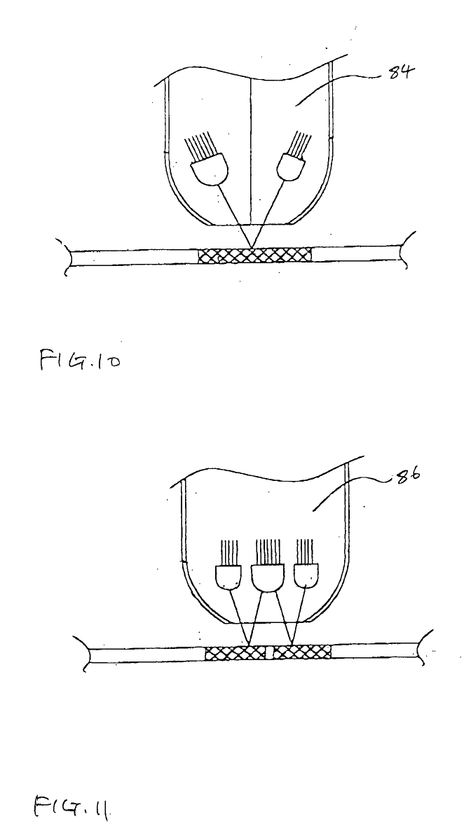

FIGS. 9 illustrates yet another embodiment of a learning aid in accordance with the present invention. The aid and a book body 78 with include text as in a typical novel or the like. At the bottom of each page in the book body, there is provided with a color label (80, 82). In this learning aid, the memory unit of the electronic means is designed such that on detecting a particular color label, the output digital signal corresponding to the reflected light is linked to a data file for audio output of the text on that page. In particular, when the pen-like object held by a user contacts the color label on that page, the speaker will read the text on that page of the book body. The learning aid is thus able to assist users (e.g. children) to read passages of text. It is envisaged that the present invention may be applied to comic books and in such case the icons may include or arranged adjacent to short dialogues pronounceable by the response generating means.

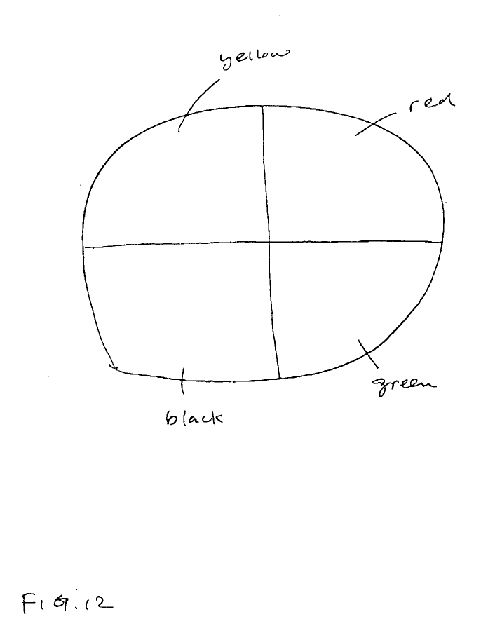

FIGS. 10 and 11 illustrate two different embodiments 84, 86 of color detector which may be used in the present invention. In FIG. 8, if the number of color used in the book is N (e.g. 8), then only N different colors or icons, labeled objects or labeled contents may be identified by the aid comprising, and the book may contain N pages only. However, by using the color detector in FIG. 11, the capacity of the learning aid can be increased. Since each color label contains two colors for each labeled object or content, the number of color combination (or resultant color) is increased to N*N, meaning the number of labeled objects or contents that can be identified can be drastically increased. Alternatively, a color detector adapted to detect icons or labels having four colors may also be used, for example, for detecting a color label such as the one shown in FIG. 12. This will further increase the number of possible color combination.

It is to be noted that learning aids or electronic books made according to the present invention may not require the presence of any book or detection base. The aids or books can thus be made to be more compact and portable and convenient for use.

It is envisaged that the present invention can be applied to other learning aids or educational toys other then electronic books. For example, an educational toy in accordance with the present invention may be in the form of a doll having a number of color labels on various parts of the doll body. In such case, the memory unit may contain means designed such that each icon or color label is located near or at a part of the doll body, and on detecting the color of the icon or the label, the output digital signal corresponding to the reflected light is linked to a file for the pronunciation of the name of that part of the doll. The icons or color labels may be attached to the doll body, or alternatively on clothing worn by the doll. For example, when the pen-like object held by a user contacts the icon or color label on the shoulder of the doll, the speaker pronounces the word “shoulder”. When the user contacts the color icon or the label on or adjacent to the left hand, the speaker pronounces the word “left hand”. The learning aid is thus able to assist users to identify body parts. In an alternative embodiment, instead of causing the speaker to produce an audio output, the memory unit can be designed to contain files with matching data files for causing a non-audio output (e.g. visual output) from the response generating means. Yet alternatively, the doll may be adapted to receive signals generated from the electronic means, and on receiving the signals the doll may be caused to perform an action such as raising an arm or blinking an eye.

It is also envisaged that the response generating means may be included in the object itself. In such case the object being a toy bear doll, for example, on contacting the shoulder of the doll, the response generating means can output the word “shoulder” and a corresponding lip movement of the doll mimicking the lip movement of pronunciation of the word.

1. A learning aid adapted to identify an icon on an object, comprising a pointer means, a central processing unit, and a response generating means, wherein said pointer means includes an optical color detector adapted to detect color or colors of said icon when placed in close proximity thereof and wherein said response generating means is adapted to provide a response corresponding to said detected color or colors.

2. A learning aid as claimed in claim 1 wherein said pointer means is a pen-like object.

3. A learning aid as claimed in claim 1 comprising a signal transmitting means adapted to convert signal detected by said optical color detector to a digital signal.

4. A learning aid as claimed in claim 3 wherein said central processing unit is adapted to receive said digital signal and generate an output signal corresponding to said detected color.

5. A learning aid as claimed in claim 4 comprising a memory means connected to said central processing unit, wherein said memory means is stored with information of colors and respective response files, and wherein said central processing unit determines said output signal therefrom based on said information.

6. A learning aid as claimed in claim 1 wherein said response generating means is a speaker adapted to output an audio signal.

7. A learning aid as claimed in claim 1 wherein said response generating means is a motor means adapted to move a part of said object.

8. A learning aid as claimed in claim 1 wherein said response generating means is a lighting means adapted to output a visual signal.

9. A learning aid as claimed in claim 1 wherein said optical color detector is adapted to detect single colors.

10. A learning aid as claimed in claim 1 wherein said optical color detector is adapted to detect multiple colors.

11. A learning aid as claimed in claim 1 wherein said icon is a two-dimensional label means or in a three-dimensional configuration on or attached to said object.

12. A learning aid as claimed in claim 3 wherein said pointer means includes said signal transmitting means and/or said central processing unit.

13. A learning aid as claimed in claim 1 adapted to be used as an educational toy.

14. A leaning aid as claimed in claim 1 wherein said pointer means is portable independent of said object.

15. A kit comprising a learning aid adapted to identify an icon on an object as claimed in claim 1 and said object.

16. A kit as claimed in claim 15 wherein said object is a book comprising one or more pages defining planar surface(s).

17. A kit as claimed 15 wherein said icon on said object is a two-dimensional label means.

18. A kit as claimed in claim 15 wherein said object is a three-dimensional object such a doll or a toy car.

19. A kit as claimed in claim 15 wherein said response generating means is included in said object.

20. A kit as claimed in claim 15 wherein said icon is in three-dimensional configuration.
